(19) United States
(12) Patent Application Publication
(10) Pub. No.: US 2005/0146113 A1
(43) Pub. Date: Jul. 7, 2005

(54) Bicycle pump seatpost

(76) Inventors: Ty Anderson, Maple Ridge (CA); Garnett RyShak, Port Moody (CA)

Correspondence Address: Clifford W. Vermette, Vermette & Co.;Box 40 Granville Square, Suite 230-200, Granville Street, Vancouver, BC, V6C 1S4, CA

(21) Appl. No.: 10/751,992

(22) Filed: Jan. 7, 2004

(51) Int. Cl. B62H 1/00

(52) U.S. Cl. 280/288.4

(57) ABSTRACT

A bicycle pump for inflating tires of a bicycle, comprising a short barrel having an elongated tube affixed thereto and an elongated barrel having a hollow interior, which receives the elongated tube in sliding engagement. The elongated barrel is slidably insertable into a hollow frame element of the bicycle, and is adapted to be clamped and used as a seatpost.

### FIELD

The present invention relates to a bicycle pump that is used as a seatpost on a bicycle.

### BACKGROUND

Conventional bicycle pumps are typically mounted with brackets on the bicycle frame. It is not unusual for the hand pump to fall off when the cyclist goes over rough road. The relative heaviness of the hand pump as compared with the flexibility of many plastic frame mounts makes it difficult for the plastic frame mounts to retain the pumps once they acquire momentum. An additional problem is the limited amount of space on modern bicycles in which to mount the hand pump.

Accordingly, it is an object of the present invention to provide a bicycle hand pump, which can function as a seatpost.

### SUMMARY OF THE INVENTION

According to the invention there is provided a bicycle pump for inflating tires of a bicycle, which comprises a short barrel having an elongated tube affixed thereto, and an elongated barrel having a hollow interior, into which the elongated tube slides. The elongated barrel is slidably insertable into a hollow frame element of the bicycle, and is adapted to be clamped and used as a seatpost.

Preferably, the elongated tube has male threads adjacent an engaging end of the short barrel, which faces an engaging end of the elongated barrel. An engaging end of the elongated barrel has female threads, which receive and register with the male threads of the elongated tube so as to hold the short barrel in abutting relationship with the elongated barrel.

Advantageously, the elongated barrel has a storage chamber for storing tire patches and a bicycle tire adapter operative to detachably couple to an end of the short barrel at one end and to a bicycle tire valve at another end.

In another aspect of the invention there is provided a bicycle having a seat, a seat clamp and a frame having a seatpost receiving frame element and a seatpost clamp. The bicycle has a bicycle pump with an outside diameter such that the pump is slidably insertable into the seatpost receiving frame element. A clamp clamps the bicycle pump to the seatpost receiving frame element.

In yet another aspect of the invention there is provided a method of carrying a bicycle pump on a bicycle, comprising forming an outside diameter of the bicycle pump such that it is slidably insertable into a seatpost receiving frame element of the bicycle, clamping the pump to the seatpost receiving frame element, and clamping a bicycle seat to a top end of the pump.

By utilizing the pump as a seat post the need to mount it along a frame element with clamps is avoided. Often such mountings fail when traversing rough terrain and the pump is either lost or the cyclist must stop and return to pick up the pump. In addition, valuable space is taken up which could be used for mounting such items as water bottles and the like. A storage space in the pump allows for storage of the pump-to-tire valve adapter and the tire patches. Other items such as jewelry and pens can also be stored.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a side elevation view of the pump in a closed position;

FIG. 2 is a side elevation view of the pump with the piston withdrawn;

FIG. 3 is a a side elevation view partly in section with the piston withdrawn;

FIG. 4 is a side elevation view of a bicycle with the seatpost of the present invention in place;

FIG. 5 is a perspective view of a nut with threadedly closes an end of the pump; and

FIG. 6 is a side view of a coupler, which couples the end of the pump to a valve of a bicycle tube.

### DETAILED DESCRIPTION WITH REFERENCE TO THE DRAWINGS

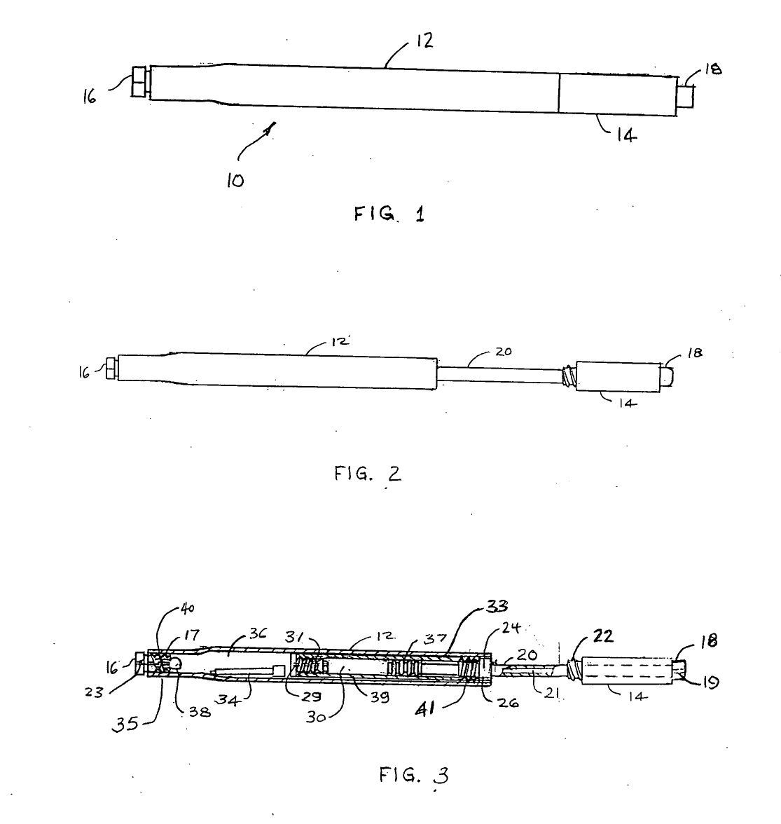

Referring to FIGS. 1 and 2, the bicycle pump 10 has a elongated barrel 12 with a nut 16 that screws into one end and a short barrel 14 having nozzle 18 with a threaded hole 19. Short barrel 14 slides into elongated barrel 12 with compressed air escaping from nozzle 18.

Referring to FIG. 3, elongated barrel 12 is hollow and has a slightly narrowed end 35 having interior threads which register with threads 17 to hold a plug 16 in place. Plug 16 has a bore 23 there through and a receptacle in its end to hold tire patches 38. Plug 16 provides fluid communication with an interior of the elongated barrel 12. A second cylinder 33 is slidably insertable in close fitting engagement into elongated barrel 12. A plug 26 has threads 41, which are threaded into threads in an end of the second cylinder 33. A head 24 of plug 26 fits snugly into an interior of elongated barrel 12. A short barrel 14 has a hollow elongated tube 20 passing centrally there through to an end thereof. Another end of tube 20 slidably passes through plug 26. A seal 37 made up of four spaced apart o-rings is mounted over a distal end of tube 20 and seals against an interior surface of the second cylinder 33. An end of the second cylinder 33 inside the elongated barrel 12 has a threaded one-way valve 31 with a passageway 29 there through.

Adjacent the second cylinder 33 is a storage space 36, which carries a bicycle tire valve adapter 34 and tire patches 38. It can also carry such items as keys and small valuables (not shown). Tube 20, which is affixed to short barrel 14, has a hollow interior 21, which is in fluid communication with threaded opening 19. Bushing 26 is threaded in end 24. When tube 20 is pushed into elongated barrel 12, threads 22 contact the threads in end 24 of bushing 26. Upon rotating short barrel clockwise, male threads 22 engage female threads in end 24 of bushing 26 pulling the short barrel 14 into abutment with end 24.

Storage chamber 36 is closed by a large bolt 16 (see FIG. 5) having threads 40 which register with threads 17 on the interior surface of an end of long barrel 12. Bolt 16 have a hollow end 41 (see FIG. 5), which carries the bicycle tire patches 38. The bicycle tire adapter 34 (see FIG. 6), which is stored in storage chamber 36, has a threaded end 42, that screws into the threaded opening 19 in nut 18. Threaded opening 19 is in fluid communication with hollow interior 21 of tube 20. End 44 of the adapter 34 has a female coupling 44 which screws onto a valve on a bicycle tire (not shown). A flexible tube 43 interconnects threaded end 42 with adapter end 44.

In operation, storage chamber 36 is at atmospheric pressure and O-rings 37 are positioned adjacent one-way valve 31. As elongated barrel 12 is moved away from short barrel 14, O-rings 37 on tube 20 move to the right in pumping chamber 30 creating a lowered pressure in the chamber 30. Air then flows through hole 23, through storage chamber 36, through opening 29 in one-way valve 31 and into pumping chamber 30, filling up pumping chamber 30 with air. With the O-rings abutting the bushing 26, short barrel 14 is then moved in an opposite direction so that O-rings 37 move towards one-way valve 31. The latter valve does not permit air to travel through it into storage chamber 36. The air is forced along hollow interior 21 of tube 20 and out through opening 19.

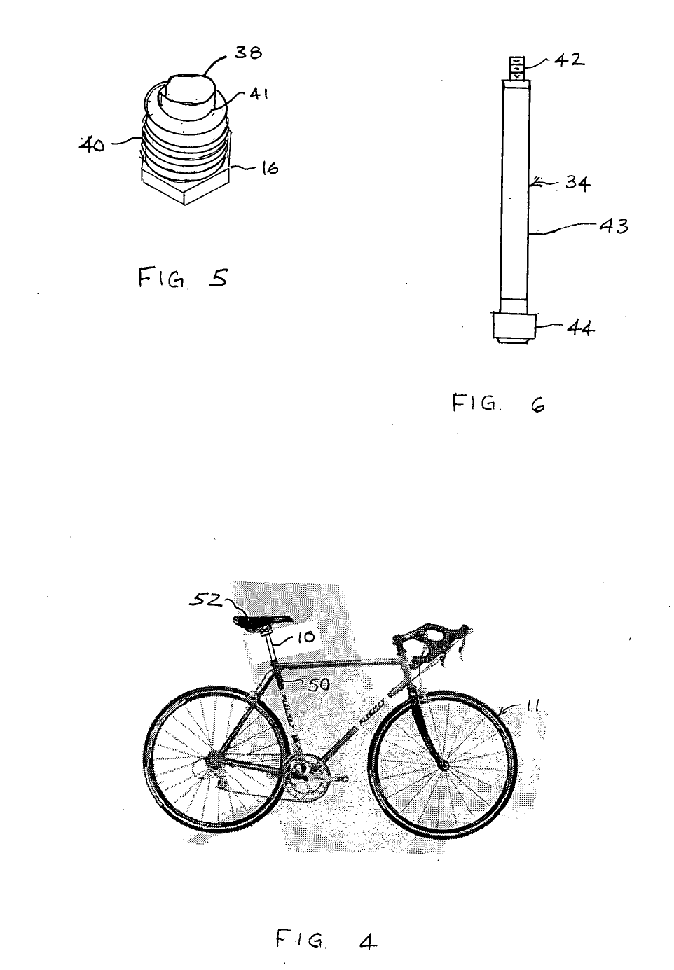

Pump 10, when assembled as shown in FIG. 1, is placed into hollow frame element 50 with elongated barrel 12 first, positioned at a desired height and then locked with a standard seatpost clamp (not shown) (see FIG. 4). The outside diameter of elongated barrel 12 and short barrel 14 are selected to be marginally less than the inside diameter of the hollow frame element 50. The latter inside diameter is the same in approximately 80% or more of the bicycles in use. Clamp shims (not shown) may be used if necessary to adapt the size of the pump 10 to the inside diameter of the hollow frame element 50. A seat 52 is clamped to a top end of the pump 10 as with a conventional seatpost (not shown).

When a rider has a flat tire, the above process is reversed. Seat 52 is removed and the clamp released to allow the pump 10 to slide out of the hollow frame element 50. Large bolt 16 is unscrewed and both the patches 38 and the adapter 34 are removed. Once the bicycle tire 11 has been patched, the end 44 of adapter 43 is screwed onto the bicycle valve (not shown) and the other end is screwed into threaded opening 19. The pump 10 is operated by, alternately, separating and then closing the elongated barrel 12 and the short barrel 14.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A bicycle pump for inflating tires of a bicycle, comprising:
(a) a short barrel having an elongated tube affixed thereto;
(b) an elongated barrel having a hollow interior, which receives said elongated tube in sliding engagement; and
wherein said bicycle pump is slidably insertable into a hollow frame element of said bicycle, and is adapted to be clamped and used as a seatpost
wherein said elongated barrel has a storage chamber for storing tire patches and a bicycle tire adapter operative to detachably couple to an end of said short barrel at one end and to a bicycle tire valve at another end.

2. The bicycle pump of claim 1, wherein said elongated tube has male threads adjacent an engaging end of said short barrel which faces an engaging end of said elongated barrel and an engaging end of said elongated barrel has female threads which receive and register with the male threads of said elongated tube so as to hold said short barrel in abutting relationship with said elongated barrel.

3. (canceled)

4. The bicycle pump of claim 1, wherein said bicycle tire adapter has a screw with an axially aligned hole therethrough adapted to register with a threaded opening in an end of said short barrel.

5. The bicycle pump of claim 1, wherein said elongated barrel and said short barrel are cylindrical and an outside diameter of said short barrel is equal to an outside diameter of said elongated barrel.

6. (canceled)

7. A bicycle pump according to claim 1, including a clamp shim that is snugly, slidably insertable into said hollow frame element and snugly, slidably insertable over said bicycle pump and operative to adapt said bicycle pump in snug engagement with an inside diameter of said hollow frame element.

8. (canceled)

9. (canceled)

10. (canceled)

11. (canceled)

12. (canceled)

13. (canceled)

14. A bicycle pump for inflating tires of a bicycle, comprising a short barrel and an elongated barrel, wherein said bicycle pump is slidably insertable into a hollow frame element of said bicycle, wherein said bicycle pump is adapted to be clamped to said hollow frame element and used as a seatpost, and wherein a top end of said bicycle pump is adapted to receive a bicycle seat, said bicycle seat being clamped to said bicycle pump.

15. The bicycle pump of claim 14, wherein said body of said pump includes:
(a) a short barrel having an elongated tube affixed thereto; and
(b) an elongated barrel having a hollow interior, which receives said elongated tube in sliding engagement;
wherein said elongated barrel has a storage chamber for storing tire patches and a bicycle tire adapter operative to detachably couple to an end of said short barrel at one end and to a bicycle tire valve at another end.

16. The bicycle pump of claim 15, wherein said elongated tube has male threads adjacent an engaging end of said short barrel which faces an engaging end of said elongated barrel and an engaging end of said elongated barrel has female threads which receive and register with the male threads of said elongated tube so as to hold said short barrel in abutting relationship with said elongated barrel.

17. The bicycle pump of claim 15, wherein said bicycle tire adapter has a screw with an axially aligned hole therethrough adapted to register with a threaded opening in an end of said short barrel.

18. The bicycle pump of claim 15, wherein said elongated barrel and said short barrel are cylindrical and an outside diameter of said short barrel is equal to an outside diameter of said elongated barrel.

19. The bicycle pump of claim 15, including a clamp shim that is snugly, slidably insertable into said hollow frame element and snugly, slidably insertable over said bicycle pump and operative to adapt said bicycle pump in snug engagement with an inside diameter of said hollow frame frame element.
